(19) United States
(12) Patent Application Publication
(10) Pub. No.: US 2006/0261117 A1
(43) Pub. Date: Nov. 23, 2006

(54) Breaking device for separating ceramic printed circuit boards

(76) Inventors: Josef Konrad, Etzenricht (DE); Gerhard Krender, Vilseck (DE)

Correspondence Address: DORSEY & WHITNEY LLP;INTELLECTUAL PROPERTY DEPARTMENT, SUITE 3400, 1420 FIFTH AVENUE, SEATTLE, WA, 98101, US

(21) Appl. No.: 10/549,434

(22) PCT Filed: Mar. 15, 2004
(86) PCT No.: PCT/EP04/02677

§ 371 Date: Jul. 14, 2006

(30) Foreign Application Priority Data
Mar. 17, 2003 (DE) 103116923
Mar. 28, 2003 (DE) 103141790

(51) Int. Cl. B26F 3/00; B65H 35/10

(52) U.S. Cl. 225/2; 225/96

(57) ABSTRACT

Breaking device (2) for singularizing ceramic conductor plates (18) along weakening lines (20) on a ceramic conductor plate (18), comprising a breaking trap (4, 6) with support plates (10, 12) displaceable relative to one another, which can be displaced from an initial position in which the support plates (10, 12) adjoin along a breaking line (14) and form an essentially flat support surface (16) into a breaking position in which the support plates (10, 12) are arranged with an angle toward one another and comprising a pinning device (50, 8) which is formed such that for a breaking operation the ceramic conductor plate is positioned against the support plates (10, 12), characterized in that

the breaking trap (4, 6) comprising two support plates (10, 12), which adjoin along a breaking line (14),

the pinning device (52, 8) comprising an oblong engagement section (58, 60) which is narrow transverse to the longitudinal direction, and

the breaking device (2) comprising a positioning element (44) which is formed such that it can position the weakening lines (20) consecutively in alignment with and above the breaking line.

The present invention relates to a breaking device for singularizing ceramic plates along weakening lines on a ceramic conductor plate comprising a breaking trap with support plates which can be displaced relative one to another and which can be displaced from an initial position in which the support plates adjoin along a breaking line and form an essentially flat support surface into a breaking position in which the support plates are arranged with an angle toward one another, and comprising a pinning device which is formed such that it positions or immobilizes the ceramic plate against the support plate for a breaking operation.

Such a breaking device is known from U.S. Pat. No. 5,069,195. In particular, the breaking device described in this document comprises a plurality of support plates displaceable relative to one another which adjoin along a plurality of parallel and perpendicular breaking lines and are connected to one another. An array of for example spring-loaded plungers is provided above the support plates such that one plunger is provided for each support plate. Further, there is provided a relatively complicated drive device with which the individual support plates can be displaced relative to one another. In operation a ceramic conductor plate is positioned on the breaking trap, the plunger array is moved downward such that each plunger is pressing with a predetermined tension against the ceramic conductor plate. During the further course the individual support plates are moved relative to one another, the plungers ensuring that the ceramic plate buckles and breaks along the breaking lines. In doing so the plungers centrally press on the individual hybrid circuits. In doing so there is a very high risk of damage to the electronic components disposed thereon or to the hybrid circuit as a whole. A pinning device with such plungers is therefore very undesirable.

Such breaking devices are used for singularizing so-called hybrid circuits. These are electronic building elements on ceramic substrates which are used in particular for high temperature applications, e.g. for motor controls in the engine compartments of vehicles or motor controls of electric motors. Often conductor paths and/or resistors are applied to the surfaces by printing methods, while electronic components are applied by the SMD-method and are welded. Often “open” electronic components, e.g. processors, are used, which are arranged an bonded on the surface of the ceramic substrates and are only subsequently sealed with a raisin. Accordingly, such hybrid circuits are sensitive. Therefore, it is a disadvantage of U.S. Pat. No. 5,069,195 to centrally place a plunger with spring-loaded initial tension on a hybrid circuit. There is the danger of damage to individual components or welding connections. A further disadvantage of U.S. Pat. No. 5,069,195 is that only hybrid circuits of same size can be broken with this breaking device, since the support plate size dictates a grid pattern of the hybrid circuits, which can be broken. Retooling is practically impossible or only possible with significant effort.

In practice significantly more than 90% of ceramic conductor plates are broken by hand. Weakening lines are, in principle, scribed for example with a diamond, or by way of perforation which typically does not extend through the substrate and is formed by a laser. Therefore, there is a preferred direction of breaking depending on which side of the ceramic plate the weakening line was formed on. This preferred direction will be referred to as “breaking direction” in the following. The reason why a large percentage of these ceramic conductor plates are still singularized by hand is that automatic breaking of this brittle material produces too much waste because minimal damages can cause the complete destruction of a ceramic conductor plate with all the hybrid substrates to be singularized. Since the individual hybrid circuits usually are very expensive, such waste is not tolerable.

Typically two different defects occur when breaking such ceramic material. They are on the one hand “wild breaks” and on the other hand “clam shell breaks”. Wild breaks run wildly all over the substrate independently of the given weakening lines. The ceramic material is not a homogeneous material which facilitates such wild breaks. A clam shell break is a flaking or chipping at the break edges. It is evident that hybrid circuits suffering from wild breaks become unusable. Clam shell breaks often do not lead to immediate failure but to failure during operation long before the actual operation life. In order to avoid such defect breaks it is highly desirable to apply the breaking forces locally on the weakening line to be broken and not anywhere on the hybrid circuit.

DE 299 19 961 U1 and DE 100 07 642 A1 describe a breaking device which according to the knowledge of the informed applicant are actually used a one of the few devices for singularizing ceramic conductor plates to a significant extent. This breaking device comprises a resiliently elastic continuous support plate which is made e.g. form a rubber material. For securely holding the ceramic plates it comprises a suction device instead of the plunger array of U.S. Pat. No. 5,069,195 which comprises several rows of commonly controlled suction openings wherein on suction opening is provided for a single hybrid circuit on the ceramic conductor plate. A breaking knife which is handled by a robot arm is positioned over the weakening line to be broken and then moved downward. It presses against the weakening line and pushes the ceramic conductor plate at this weakening line against the rubber support until it breaks. The energy stored in the rubber support is suddenly released at breaking point which imposes additional forces and possibly breaks caused by these in the ceramic conductor plates. In that way a ceramic conductor plate is turned into a plurality of longitudinal rows of several hybrid circuits arranged in series in a first breaking step by breaking. These circuits must be gripped and transported to a further singularizing station where they are broken along the weakening lines which are disposed in longitudinal direction subsequent to one another on these rows to separate individual hybrid circuits from one another. This second breaking device in principle functions the same way as the first and is constructed accordingly. There is a problem in the transport of the rows of hybrid circuits from the first breaking device to the second breaking device. The rows cannot be gripped from their longitudinal sides since there are no gaps between the individual fragments of the ceramic plate in which a gripper could grip. Accordingly the rows have to be gripped by their ends. However, breaking events often occur with these breaking devices perpendicularly to the row, so that each row cannot be gripped by the longitudinal ends and be transported to the next breaking device. Such a irregularly processed row must be moved along by hand, for example.

With this described breaking device of the prior art hybrid circuits of a certain size can be singularized with relative ease. Also the occurring waste is within a tolerable degree. However, a disadvantage of this breaking device is that it is designed for certain hybrid circuit sizes. Hybrid circuits with significantly different measurements must be broken on special breaking devices, since valve arrangements and so on are no longer compatible. A refitting to other hybrid circuit formats can therefore not be achieved without problems. Further, there are problems when the individual hybrid devices are too small, e.g. smaller than 15 mm in one direction. As a result of the resiliency of the support relatively large forces have to be applied for breaking the hybrid circuits along the weakening lines. The smaller the hybrid circuits are, the larger the forces which are released when the elastic material moves back into its initial position after breaking. It can occur that suction forces are no longer sufficient to hold individual rows to the support and the individual hybrid circuits can therefore break in an uncontrolled manner and distribute over the support surface.

All breaking devices of the state of the art have in common that they can only break in one direction, e.g. ceramic plates are always broken in the same direction relative to the electronic components arranged on the ceramic conductor plate. In U.S. Pat. No. 5,069,105 a breaking is performed wherein a part of the ceramic conductor plate is bent downward, whereas in DE 299 19 961 U1 and DE 100 07 642 A1 a breaking is performed wherein both fragments of the ceramic plate are bent upwardly relative to one another. It has already been mentioned how the weakening lines are formed on the ceramic conductor plates. All these weakening lines have in common that they need to be bent in a certain direction to achieve a clean break. Therefore the weakening line in U.S. Pat. No. 5,069,195 has to be arranged on the upper side of the ceramic conductor plate to achieve a clean break, while the weakening line in DE 299 19 961 U1 and DE 100 07 642 A1 has to arranged on the backside of the ceramic conductor plate. Therefor it has to be clear before outfitting the ceramic conductor plate in which direction breaking should be performed at the end of the manufacturing process.

In light of the described problems of the state of the art it is an object of the present invention to provide a breaking device of the described type which is simply built with which hybrid circuits of the most different sizes can be singularized with minimal waste, and the breaking forces are transferred to the ceramic conductor plates, if possible, only along the breaking line.

According to the present invention the problem with a breaking device of the described type is solved by the breaking trap comprising two support plates which adjoin along a breaking line when the pinning device comprises an oblong section of engagement which is preferably narrow transverse to the longitudinal direction and by the breaking device comprising a positioning means which is formed such that the weakening lines can be consecutively positioned in alignment with and above the breaking line.

The invention further relates to a breaking device for singularizing ceramic conductor plates along weakening lines on a ceramic conductor plate, comprising a breaking plate with several support plates displaceable relative to one another which can be displaced from an initial position in which the support plates adjoin at a breaking line and form a flat support surface, to a breaking position in which the support plates are arranged with an angle to one another, characterized in that the breaking trap comprises two support plates adjoining at a breaking line, wherein a breaking device further comprises:

a breaking knife which is arranged in the breaking direction such that it can be positioned over the breaking line and can be moved in direction of the breaking line and further;

a drive to move the breaking knife; and

a positioning element which is designed such that it can position the weakening lines of a ceramic conductor plate consecutively in alignment with and above the breaking line;

wherein the support plates are arranged resiliently such that they are displaced downwardly beyond the breaking line in the breaking position during the course of movement of the breaking knife.

The oblong engagement section of the pinning device is designed such that it can be arranged at the edge portion of the individual hybrid circuits or chips and can transmit the necessary forces thereabouts. Typically an edge portion of about 0.5-0.6 mm is provided on each chip up to the first components. It is an important feature of the present invention to use this edge portion of the chips for positioning or immobilizing. To that end the pinning device has an oblong engagement section which is preferably narrow in transverse direction to its longitudinal direction and preferably has a knife edge-like form. It is particularly preferred if the engagement section is narrower than 1.5 mm, in particular narrower than 1 mm, preferably 0.1-0.8 mm narrow and most preferred 0.5-0.7 mm narrow. During tests an engagement section which was 0.6 mm narrow has proven useful. It can be useful to form the contact surface of the engagement section of the pinning device or the breaking knife with a friction increasing or resilient material, e.g. by providing a layer with such a material. The resilient material can compensate irregularities on the ceramic conductor plate to a certain degree. A rubber-like material has proven useful. The pinning device can also be formed of several individual elements which are e.g. distributed over its longitudinal direction. It can e.g. have a comb-like form.

The pinning device can be positioned on the weakening line along which breaking should occur for positioning the ceramic conductor plate or also on parallel weakening lines or chip edges. The pinning device can be designed resiliently to passively join the movements of the support plates or it can be actively driven and displace the support plates for the breaking operation. There can also be provided a combination of active drive and resilient construction.

A further advantage of this construction is that the ceramic conductor plate has to be positioned exactly on the support plate only in one direction, e.g. it must be positioned such that the weakening line to be broken is aligned over the breaking line of the breaking trap. Thus it is sufficient to let the positioning element work against one end of the ceramic conductor plate, e.g. it is sufficient to provide a sufficiently wide positioning element which ensures perfect alignment of the ceramic plate in feed direction and approaches the correct position of the weakening line over the breaking line. Thereby a tilting or sideways friction of the ceramic plates on guiding abutments is precluded, whereby undesired breaks during positioning can be precluded almost entirely. The positioning element can further displace the ceramic conductor plate for any desired distance which can be fed for example. In consequence ceramic conductor plates with all sorts of differently arranged weakening lines can be singularized with one breaking device. A complete refitting of the breaking device to a different grid pattern it not necessary.

A further advantage of the stepwise positioning is that even when wild breaks, occur, the positioning device moves the respective fragments further along and the fragments are subsequently singularized further and merely the actually defect hybrid circuits have to be sorted out.

Preferably the support plates comprise breaking line ends adjacent to the breaking line, whereby the breaking trap is designed such that the breaking line ends can selectively be moved in a breaking position upwardly or in a breaking position downwardly. It is especially preferred if during displacement of the breaking line ends in a breaking position upwardly a engagement section of the pinning device is positioned over the breaking line. This ensures an exact amount of force to the weakening line to be broken. On the other hand, it is preferred if during displacement of the breaking line ends to a breaking position upwardly to arrange two parallel engagement sections of the pinning device each at the breaking line adjacent to the breaking line to be broken or at the next edge of the ceramic plate parallel to the breaking line. Alternatively it is possible to immobilize the ceramic conductor plate with the positioning device whereby engagement sections of the positioning device are arranged at weakening lines which e.g. run perpendicular to the weakening lines to be broken. It can be useful to design the positioning device such that it can move essentially in parallel to the surface of the support plates during breaking.

The displacement of the support plates can occur actively, for example by a drive of the support plates which e.g. is positioned with the movement of the engagement sections of the pinning device. Alternatively, the engagement sections can move the support plate against an elastic force. It is useful to provide a means which returns the support plates to an initial position. It has become clear that in contrast to the aforementioned prior art DE 299 19 961 U1 and DE 100 07 642 A1 the path of movement into the breaking-position is not a critical parameter. Normally it is sufficient to displace the support plates from their initial position by a few tenths of a millimeter to a few millimeters. A further displacement beyond the breaking point does not have a negative impact on the ceramic conductor plate. In contrast to the aforementioned art a very exact adjustment is therefore not necessary.

With the possibility of the selective displacement of the support plate of the breaking trap downwardly or upwardly it is possible to break ceramic conductor plates with one breaking device independently of which side, i.e. on which side of the components or on the backside, the weakening lines are arranged. It is even possible to break ceramic conductor plates which comprise weakening lines on the front side and the backside, respectively.

The possibility to selectively break “upwardly” or “downwardly” is also relevant for those problems where it is not possible to reliably break into one direction. With such problems it can be useful to bend or break the ceramic conductor plate first in one direction and then in the other direction to reliably realize the singularizing of the individual chips. This can typically be achieved by both engagement sections of the pinning device being in engagement with weakening lines/edge sections of the ceramic conductor plates which are in parallel with the breaking line. For breaking or bending downwardly one of the two engagement sections will be removed, e.g. by folding, and then moving with the second engagement section similar to a breaking knife onto the breaking site and breaking or bending the ceramic conductor plate downwardly. In principle, it is possible to initially break either upwardly or downwardly. Such a problem exists for example when metal conductor paths on the surface of the ceramic conductor plate extend over the edges of the individual chips. When breaking such a ceramic conductor plate downwardly first (because this is the breaking direction of the weakening line), typically the individual chips are still connected by the conductor paths. A subsequent bending inwardly puts tensile stress on the conductor path and leads to snapping of the conductor path and finally to complete singularizing along the weakening line.

Preferably the engagement sections of the pinning device are displaceable relative to one another. With a pinning device with parallel engagement sections this allows an adjustment of the distance between the engagement sections and thereby an adjustment to the distances of the individual breaking lines. The displacement can e.g. be done manually, an automatic displacement is preferred such that the breaking device can automatically move the engagement sections to the correct distance.

Preferably the pinning device comprises a breaking knife which is connected to the breaking device such that it is positioned over the breaking line and can be moved in direction of and beyond the breaking line, the support plates being arranged resiliently such that the breaking line ends of the support plates are displaced beyond the breaking line downwardly into the breaking position during the course of the movement of the breaking knife. An engagement section of the pinning device or the engagement sections of the pinning device can e.g. be provided as a breaking knife. It can be useful to form the engagement edge of the breaking knife thinner than the engagement section of the pinning device would usually be formed.

It is noted that when mentioning that the breaking line ends of the support plates can be displaced upwardly or downwardly this statement is to be understood relatively and in particular also includes the case wherein the support plates can be pivoted relatively to the breaking line upwardly or downwardly wherein the breaking line ends essentially maintain their position.

Preferably the breaking line ends of the support plates of the breaking traps can be displaced upwardly and further preferably these support plates are arranged such that during the movement of the breaking line ends of the support plates upwardly a gap disposed in between these is increased and accordingly during operation a gap between the fragments of a ceramic plate is increased. A principal problem of singularizing ceramic conductor plates is that it is often problematic to transport the fragments further since the individual fragments are so close next to one another that it is practically impossible to grip the fragments with a gripper or different means. In the breaking device of the present invention this problem is solved by upwardly displacing at least one of the support plates of the breaking traps typically from the breaking position into a gripping position which is above the initial position. Through this upward movement the distance between the support plates and accordingly also between the fragments is significantly increased. When the distance is large enough, gripping can then be performed to further transport the fragment. The breaking trap of the present invention accordingly has four operational cycles: (i) the support surface is in the initial position; the positioning element positions the ceramic conductor plate above the breaking line. (ii) The breaking trap is moved to the breaking position and the ceramic conductor plate breaks along the weakening line. (iii) At least one of the support plates of the breaking trap is lifted above the initial position such that a distance between the breaking line ends of the support plates is obtained. (iv) The breaking trap is in the gripping position and the broken fragment of the ceramic conductor plate is gripped and transported away and the support plates are brought back into the initial position.

Preferably the breaking device comprises a transport element which is formed such that it can operatively be moved into the enlarged gap between the fragments of a ceramic conductor plate and then be displaced to transport a fragment away. The transport element can for example be a slider wherein the lower edge of the slider is operatively brought into contact with the edge or boundary of the part to be transported of the transport plate. Preferably the positioning element is simultaneously also the transport element and especially preferred the engagement section of the pinning device simultaneously serves as positioning element and transport element. The pinning device can e.g. be disposed on the arm of a processing robot. Such processing robots work very precisely and can position the ceramic plates sufficiently exact with the weakening line over the breaking line with relative ease to break the ceramic conductor plate exactly at the weakening line and grip or emerge into the gap which is formed in the tripping position between the fragments of the ceramic conductor plate to transport one of the fragments away.

Preferably a coupling device is associated with the breaking trap such that it synchronizes the operation of the support plates. The efficiency of the breaking trap is best when both support plates of the breaking traps have the same distance into the breaking position, i.e. if their movement is synchronized. It is especially preferred if the path of the breaking knife is essentially along the bisecting line of the obtuse angle between both the support plates of the breaking trap.

Preferably there is provided a control for the breaking device which adjusts or synchronizes the movements of the breaking trap, the breaking knife, the positioning element, and/or the transport element, and/or the breaking direction (breaking trap “downwardly” or “upwardly”) and which preferably comprises a input interface through which the measurements of the ceramic conductor plates to be singularized and the positions and/or distances of the weakening lines arranged thereon can be input. The ceramic conductor plates to be broken typically comprise a plurality of hybrid circuits which are arranged in rows and columns on the ceramic conductor plates. Often the ceramic conductor plates still comprise continuous lateral edges on all four sides of the ceramic conductor plates, which serve as frame or supporting edge for the previous manufacturing processes and prevent disintegration of the ceramic conductor plates during previous manufacturing operations in single fragments along the weakening lines. Such ceramic conductor plates are called “griddle”. Typical sizes of such griddles are 5.5×7.5 inches, 5×7 inches, and 4×6 inches. Typically hybrid circuits of the same size are arranged on such a griddle, which can have different sizes depending on the circuit. Such hybrid circuits can have a size of 30×25 mm down to 15×15 mm and less. With the device according to the invention all ceramic conductor plates can be singularized independently of their size, the presence of an edge, or the size of the single hybrid circuits. It is merely necessary to input the individual measurements into the control of the breaking device. The positioning element then positions the conductor plate correctly into the correct position. Additionally sensors can be provided, for example optical sensors or sensing devices, which determine whether a conductor plate is in the correct position, e.g. with the weakening line above the breaking line. It is especially preferred to provide a sensing device with which it can be determined before the first breaking of the ceramic conductor plate if this ceramic conductor plate has the required measurements. Thereby it can be avoided that a ceramic conductor plate which for example has broken at the supporting edge during the manufacturing process, will be broken completely wildly by the breaking device.

Preferably there is provided a retardation means which retards the impulse transmitted to the ceramic conductor plate by the positioning element. Typically the friction between the supporting plates and the ceramic plates is relatively low. It can occur that the conductor plate moved by the positioning element can continue to move a bit due to the momentum transferred to it by the positioning element. To avoid this and to ensure a safe and correct positioning of the ceramic conductor plate in any case it is preferred to provide a retardation means. The retardation means can for example consist of a set of suction openings which e.g. are arranged close to the breaking line and through which air is suctioned by a pump. The air stream through these suction openings can be kept essentially constant during operation of the breaking device such that no exceedingly complex control is necessary. These suction openings have the effect that they pull the ceramic conductor plate against the support and ensure an increased friction. The friction is still low enough to enable transport and positioning of the ceramic conductor plate by the positioning element. It can be adjusted such that a further movement over the ceramic conductor plate beyond the actual positioning location is reliably prevented.

Preferably the breaking device comprises a turning device with which during operation the ceramic conductor plate and/or its fragments to be conducted can be turned around an axis perpendicular to the support plates. The turning device is for example a turning plate on which the ceramic conductor plate or the fragments are pushed. The turning device can also be a gripper, which lifts the ceramic conductor plates or fragments, turns them and sets them back down. Alternatively, it is also envisioned to form the breaking knife rotatable about its vertical axis and to turn the ceramic plate or fragments with this breaking knife. The idea of turning is based on the fact that typically several hybrid circuits are arranged in columns and rows next to one another. Thereby the first breaking operation only performs a separation along the individual rows. The hybrid circuits ate still connected in one row with another. To also separate these, they can e.g. be turned and be broken at the same breaking trap at which the step of separating into individual rows was performed. It can e.g. be envisioned to break a ceramic conductor plate at a breaking trap into individual rows and to then push the rows essentially parallel to one another onto a turn table. When for example all rows are separated and are positioned on the turntable, the turntable can e.g. be turned by 90°, depending on the angle the weakening lines of the rows and columns on the ceramic conductor plate are arranged in, and then be returned individually or collectively back to the breaking trap to thereby singularize the rows into the individual hybrid circuits.

Preferably there is provided a second breaking trap which is arranged in such a way in the breaking device that its breaking lines viewed in the plane of the support plate is arranged relative to the breaking line of the first breaking trap with an angle. Typically this angle will be 90°, i.e. the angle with which the weakening lines are arranged on the ceramic conductor plates. The singularized rows of individual hybrid circuits can then be moved from the breaking line of the first breaking trap by simply pushing them to the side. They can then be positioned by the same or a different positioning device such that the weakening lines of the row of hybrid circuits are consecutively positioned over the breaking line of the second breaking trap and separated by the associated breaking knife. Further it is possible to arrange several of or the singularized rows/columns essentially in parallel to one another on the second trap, to collectively separate them thereabouts. Preferably the breaking traps are essentially identical to one another. The second breaking trap can be designed narrower than the first breaking trap. It can be useful to use the pinning device and/or the transport device of the first breaking trap for the corresponding operation steps at the second breaking trap. It can be especially preferable to perform all positioning breaking and transport tasks with the engagement section(s) of the pinning device. For increasing the cycle time it can also be preferred to provide the corresponding means for each breaking trap.

The invention further relates to a method for singularizing ceramic conductor plates along weakening lines on a ceramic conductor plate, comprising the following steps:
(a) providing a breaking trap with two support plates displaceable relative to one another which can be displaced from an initial position in which the support plates adjoin along a breaking line and form a essentially flat support surface into a breaking position in which both support plates are arranged in an angle to one another;
(b) positioning of a ceramic conductor plate on the support plates in the initial position such that a weakening line along which breaking should occur is located essentially above the breaking line;
(c) lowering a pinning device comprising two oblong engagement sections onto the ceramic conductor plate such that they exert a pinning force in the zone of two weakening lines which are adjacent to the weakening line along which breaking should occur on the ceramic conductor plate;
(d) breaking the ceramic conductor plate by raising the breaking line ends of the support plates of the breaking trap upwardly into the breaking position;
(e) raising the pinning device and releasing the fragments of the ceramic support plate;
(f) returning the support plates into the initial position;
(g) positioning the ceramic conductor plate on the support plates such that a further weakening line along which breaking should occur, is essentially above the breaking line; and
(h) repeating the steps (c) to (g) until the ceramic conductor plate is broken along the weakening lines along which breaking should occur.

The invention further relates to an alternative method for singularizing ceramic conductor plates along weakening lines on a ceramic conductor plate, comprising the following steps:
(a) providing a breaking trap with two support plates displaceable relative to one another which can be displaced from an initial position, in which the support plates adjoin along a breaking line and form a essentially flat surface, into a breaking position in which both support plates are arranged in an angle to one another;
(b) positioning of a ceramic conductor plate on the support plates in the initial position such that a weakening line, along which breaking should occur, is located essentially above the breaking line.
(c) breaking the ceramic conductor plate by lowering a breaking knife which is essentially aligned with the weakening line against the weakening line and against a predetermined force of the support plates and thereby displacing the support plates downwardly into the breaking position;
(d) raising the breaking knife;
(e) returning the support plates into the initial position;
(f) positioning the ceramic conductor plate on the support plates such that a further weakening line, along which breaking should occur, is located essentially above the breaking line; and
(g) repeating the steps (c) to (f) until the ceramic conductor plate is broken along weakening lines, along which breaking should occur.

Preferably the method further comprises the step of displacing the support plates upwardly into a gripping position for increasing the gap between the fragments of a ceramic conductor plate.

Preferably the method further comprises gripping in the gap between the fragments and transporting away the fragments. It is noted that as used herein “gripping” does not necessarily mean gripping with a gripper from both sides. Rather, this term should also include pushing or sliding from one side.

Preferably the movements of the support plates are performed synchronously.

The invention and embodiments of the invention are described below in connection with an example. There is shown:

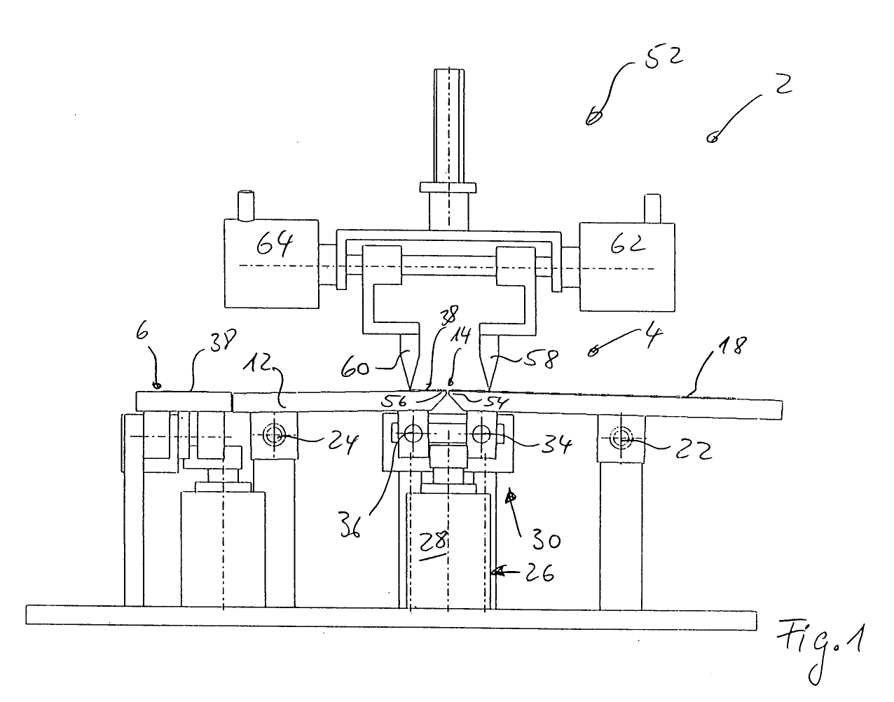

FIG. 1 a side view of a breaking device according to the invention;

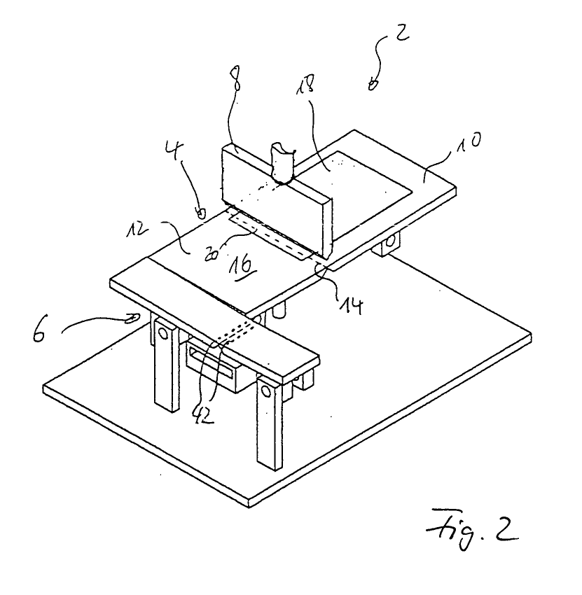

FIG. 2 a perspective view of a breaking device according to the invention according to an alternative embodiment;

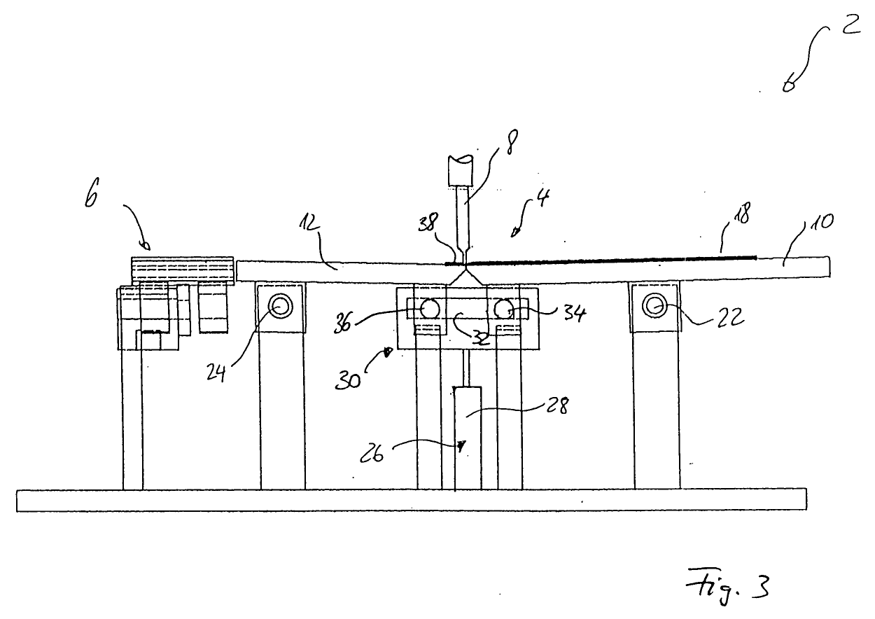

FIG. 3 a side view of a breaking device of FIG. 2; and

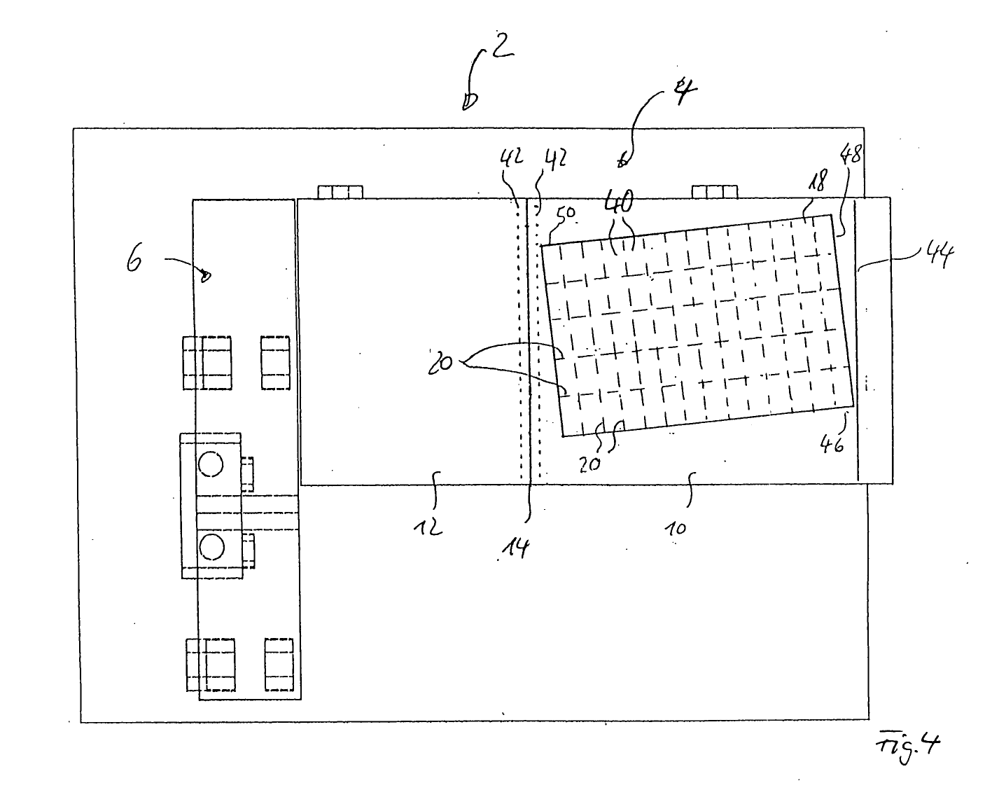

FIG. 4 a top view of the breaking device.

FIG. 1 shows a breaking device 2 according to the invention comprising a first breaking trap 4 and a second breaking trap 6. Further there can be seen a pinning device 52, which is connected to a robot cell (not shown). The pinning device 52 is preferably connected to this manipulating arm. Such manipulating arms can perform translational movements in all dimensional directions within their reach. To a certain degree they can also perform rotational movements. Such robot cells are able to position tools connected to the robot arms, e.g. the pinning device 52, very precisely. Programming of such robot cells can be performed from conventional PCs over suitable interfaces/ports. A rotor cell which is especially suitable for such applications is the “baumann-ro/box” with the integrated Bosch Scara robot. It can be seen that the breaking trap 4 comprises two support plates 10 and 12, adjoining along a breaking line 14 and forming a essentially flat support surface in an initial position. In FIG. 1 the breaking trap 4 is shown in a breaking position in which both support plates 10 and 12 are raised at their breaking line ends 54, 56 adjacent to the breaking line 14 upwardly into a breaking position. The support plates 10 and 12 can be made of any material. It is preferred if this material is wear-resistant, since the material of the ceramic conductor plates is very abrasive. It is preferred if it is an antistatic material to avoid electrostatic charging of the ceramic conductor plates caused by displacement of the ceramic conductor plates on the surface of the support plates 10, 12. Electrostatic charging would increase the risk of damage to components of the ceramic conductor plates. Suitable materials are e.g. steel, especially ground steel, certain plastic materials are also possible, however.

In FIG. 1 and more so in FIG. 2 there can be seen a ceramic conductor plate 18 which is positioned with its weakening lines 20 in alignment with and above the breaking line 14. The pinning device 52 immobilizes the ceramic conductor plate 18 in this position. In particular, the pinning device 52 comprises two engagement sections 58, 60 which are oblong elements which taper off downwardly. The engagement sections 58, 60 are brought to the weakening lines 20 which are parallel to the weakening line to be broken, or they start at the narrow edge section of a hybrid circuit. It can further be seen that the engagement sections 58, 60 of the pinning device 52 are disposed displaceably relative to one another. In particular, there can be seen the drive motors 62, 64 which can adjust the position of the engagement sections 58, 60 by means of a displacement screw device. In particular, the drive motors 62, 64 are designed e.g. as actuators such that they can move each of the engagement sections 58, 60 to an exactly determined position in space.

Further, there can be seen a coupling device which will be described further in connection with FIG. 3 in more detail, as well as a drive 28 for moving the support plates 10 and 12.

Referring to FIG. 1, the drive 28 has raised the support plates 10 and 12 and thereby the ceramic conductor plate 18 from the initial position upwardly into the breaking position. Thereby the weakening line 20 was broken along the breaking line 14. The movement of the support plates 10 and 12 has occurred against an elastic force of the pinning device 52. Theoretically it is also possible to arrange the support plates 10 and 12 such that they can pivot during the movement around the pivot point defined by the engagement sections 58 and 60 whereby an elastic resiliency of the pinning device 52 is not necessary.

In FIGS. 2 and 3 an alternative embodiment of the breaking device 2 is shown. Corresponding elements of the individual breaking devices 2 have the same reference numerals. In principle, features having been described with reference to one of the embodiments can be provided accordingly at different embodiments. In particular, the pinning device 52 in this embodiment can be designed essentially the same as in the embodiment of FIG. 1. The breaking knife 8 shown in this embodiment corresponds to the pinning device 52 or is a part thereof. In particular, the breaking knife 8 can form one of the engagement sections 58, 60 of the pinning device. The second engagement section of the pinning device 52 is then preferably moved sideways such that the function of the breaking knife 8 or the other engagement section if not affected. Alternatively, the second breaking device can also be removed. However, the breaking knife 8 can also form the pinning device 52, 8 in itself. It can be seen in FIG. 2 that the breaking knife 8 is positioned in alignment and above the breaking line 14.

When the breaking knife 8 is lowered downwardly it meets the weakening line 20 of the ceramic conductor plate 18 and pushes it against the breaking line 14 of the breaking trap 4 downwardly into the breaking position.

In FIGS. 1 and 3 the breaking position of the breaking trap 4 is shown, wherein the support plates 10 and 12 do not form an essentially flat support surface 16 but are arranged with an angle toward one another.

The first and second breaking trap 4 and 6 are formed essentially identically. The second breaking trap 6 in the present embodiment is arranged with an angle of 90° relative to the first breaking trap, i.e. the breaking lines 14 of the two breaking traps form an angle of 90°. This angle is determined by the angle of the weakening lines 20 on the ceramic conductor plate 18 which is typically 90°. For special applications other angles can theoretically also be envisioned. Then it is preferable to arrange the second breaking trap in a corresponding angle to the first breaking trap. Since at the second breaking trap 6 only strips or rows of hybrid circuits of the ceramic conductor plate 18 need to be broken, this breaking trap is significantly narrower than the first breaking trap 4. There can also be situations, however, where it is preferred that the second breaking trap 6 is approximately as wide or wider than the first breaking trap 4.

FIG. 3 shows a side view of the breaking device 2 of FIG. 2. Again there can be seen the breaking knife, the first breaking trap 4, and the second breaking trap 6. Further, there can be seen the support plates 10 and 12 of the first breaking trap 4. There can be seen that the support plates 10 and 12 are pivotably mounted at 22 and 24. The first and second support plate can move around the pivot points 22 and 24 relative to one another. In particular, it can be seen that in FIG. 3 the first and second support plates 10 and 12 are displaced downwardly at the breaking line 14. In particular, in FIG. 3 they are displaced into the breaking position in which the two support plates 10 and 12 do not form a flat support surface but are arranged with an angle toward one another. A relatively short distance between the initial position and the breaking position is sufficient since the breaking force of the breaking knife edge is transmitted directly onto the breaking line 20 and accordingly the breakage occurs already at a relatively minor change of angle of the support plates 10 and 12. When comparing FIGS. 2 and 3 it can further be seen that the breaking knife 8 can be moved downwardly onto the breaking line 14 in the initial position and can be moved further beyond the breaking line 14 from the initial position downwardly. During this further movement the breaking knife 8 presses against the ceramic conductor plate 18 in the zone of the weakening line against the free ends of the support plates 10 and 12 and pushes these free ends downwardly. In order for this movement of the support plates 10 and 12 to be performed in a controlled fashion a means 26 is provided which provides a certain counter force such that the movement occurs resiliently against a counter force. The means 26 can functions according to all kinds of different principles. It is preferred if the means 26 is constructed such that it does not abruptly release stored energy after the breakage. Rather, the support plates 10, 12 should either remain in the breaking position until they are again actively moved, or they should only gradually move back into the initial position. Springs which are coupled with damping elements or pneumatic devices can be used. However, it is preferred to provide a drive 28, e.g. in form of a linear servo-motor or a linear actuator, which on the one hand can be moved downwardly against a determined counter force and on the other hand can also perform the driving of the support plates 10, 12. A further advantage of such a drive motor is that the exact position of the support plates 10, 12 can always be determined by the linear servo-motor 28 and thereby an exact positioning in space is possible.

In this regard it is noted that the path of movement of the breaking trap 4 and 6 into the breaking position in the breaking device 2 according to the present invention is not critical, which is an advantage over the prior art because extensive adjustments before start-up are not necessary.

In FIG. 3 there can further be seen a coupling device 30 with which the support plates 10, 12 of the breaking trap 4 are associated to synchronize the movements of the support plates 10, 12. In particular, the coupling device comprises a guide rail 32 in which pins 34, 36 associated with the support plates 10, 12 are guided. The coupling device 30 is connected such that it only has degrees of freedom of movement upwardly and downwardly but cannot be tilted or pivoted. Thereby a synchronization of movement of the support plates 10, 12 is ensured the coupling device 30 can also be implemented mechanically in a different fashion, e.g. by two lever connections which extend from the drive 28 to the support plate 10 and support plate 12, respectively, and are each connected with joints at both sides. It is also possible to provide the support plates 10 and 12 each with their own drive motor and electronically to couple these with one another such that only essentially synchronous movements of the support plates 10, 12 are possible.

In FIG. 3 there can also be seen a fragment 38 of the ceramic conductor plate 18 which has already been broken off. After raising the breaking knife 8 from the position shown in FIG. 2 and returning the support plates 10, 12 to the initial position there is only an extremely narrow gap between the ceramic conductor plate 18 and the fragment 38 which is not sufficient to move the fragment 38 in the illustration of FIG. 3 in a leftward direction. It could be contemplated to provide a gripper with which the fragment 38 is gripped at its lengthwise ends and is further transported. However, this is disadvantageous because occasionally breakage can occur transverse to the longitudinal direction of the fragment 38. Such an additionally broken fragment 38 cannot be transported further without problems and would seriously impair operation of the breaking device with such a construction of a transport element. It is therefore preferred to design the drive 28 of the breaking device 2 according to the invention for the support plates 10, 12 such that the free ends of the support plates 10, 12 can be raised above the initial position such that a gap between the free ends of the support plates 10, 12 and accordingly between the fragment 38 and the ceramic conductor plate 18 is formed. A transport element, e.g. one of the engagement sections 58, 60 or the breaking knife 8 or a different suitable transport element can immerge into this gap and can move the fragment 38 from its longitudinal side in a leftward direction in the representation of FIG. 3. Therefrom the fragment 38 can be received for further processing.

FIG. 4 shows a top view of a breaking device 2 according to the present invention. In particular, there can be seen the first and second breaking trap 4, 6 arranged with an angle of 90° toward one another. There can be seen the support plates 10, 12 of the first breaking trap and the breaking line 14. Further, there can clearly be seen the ceramic conductor plate 18 which in this form is also referred to as “griddle”. A griddle typically comprises several rows and columns of individual hybrid circuits 40 which are each separated by weakening lines 20.

In many cases there is additionally arranged a supporting edge around the rows and columns of hybrid circuits 40 which confers additional stability to the griddle or the ceramic conductor plate 18 for the previous manufacturing operations. Such a supporting edge is not shown in FIG. 4. Typically the supporting edge is also arranged with breaking lines 20. The supporting edge can also be broken away with the breaking device 2 according to the present invention. It is noted that the integration of the hybrid circuits 40 has meanwhile progressed so far that the individual components are arranged as a distance of only 0.4 to 0.6 mm from the breaking edge. Therefore the pinning device or the breaking knife 52 or 8, respectively, must be implemented in such a way and moved to such an exact degree that it can reliably immerge into this very narrow zone between two rows of hybrid circuits 40 and break the ceramic conductor plate 18 thereabouts or immobilize the ceramic conductor plate thereabouts, respectively. The positioning of the ceramic conductor plate 18 has to be achieved with an accordingly exact degree, i.e. the positioning of the weakening line 20 after positioning the ceramic conductor plate 18 must be definable in an accordingly exact degree. There is provided a retardation means 42 which in the present embodiment is provided in the form of a set of suction openings in the zone of the free ends of the support plates 10, 12 near the breaking line 14. A certain air volume is essentially continually suctioned such that the ceramic conductor plate, as soon as it is moved into the zone of the retardation means 42 is suctioned with a certain suction force against the support plates 10, 12 and is thereby retarded. In part, this is important in order to retard the momentum of the ceramic conductor plate 18, which momentum is transmitted by the movement during positioning. On the other hand, the position after positioning of the ceramic conductor plate 18 is immobilized, i.e. against vibrations and impacts which occur during operation of the breaking device 2 or which are brought into the system by different means. The suction force of the retardation means 42 is preferably adjusted such that a certain amount of air is continually suctioned through the suction opening. Alternatively, it is also possible to switch off the suctioning device after breakage to move a fragment 38 for the ceramic conductor plate 18 along further.

The positioning of a griddle or of a ceramic conductor plate 18 on the breaking trap 4 and accordingly on the breaking trap 6 functions as follows. The griddle 18 is moved from a previous processing station conventionally onto the breaking trap 4. The twisted position of the griddle 18 shown in FIG. 4 is actually a quite extreme position which practically does not occur during operation. The griddle 18 is then on the support plate 10 of the breaking trap 4 or on a previous positioning surface. A positioning element 44, which in the engagement section with the griddle 18 is an essentially oblong element, is moved essentially perpendicularly to its longitudinal direction towards the griddle 18 and touches it initially at the corner 36. As a result of its further movement it transmits a torque to the corner 46 which tends to align the griddle 18 such that it comes into adjoinment with the positioning element 44 along the entire end border 48. As soon as the section of the front corner 50 is in the zone of the retardation means 42, this section is additionally retarded, whereby the torque is increased, and the alignment of the griddle 18 is assisted additionally. In this way it is ensured that the griddle is positioned correctly as soon as the first weakening line 20 is positioned above the breaking line 14. The breaking device 42 keeps the griddle, 18 in position for the actual breakage. It can be preferable to use the breaking knife 8 as positioning element 54. It can also be preferable to position a retardation means 42 further away from the breaking line 14, especially if the retardation means 42 can assist positioning at such a position.

There can be provided several retardation means 42 distributed over the transport means 10, 12. Optionally one or several retardation means 42 can also be provided at an upstream positioning surface.

A separated strip or fragment 38 with several hybrid circuits is transported by a transport element or the breaking knife 8 leftward to the second breaking trap 6 and is essentially positioned in the same way thereabouts and then broken. The singularized hybrid circuits are then processed further or packaged. Instead of the second breaking trap 6 or in addition to the second breaking trap 6 there can be provided a turning device. This can be a surface which for example adjoins the flat surface 16 of the first breaking trap 4 in the initial position and which can be turned about any angle, preferably about 90° around the vertical center line of this surface. Thereby four weakening lines 20 can be broken at one breaking trap which are not in parallel to one another and, in particular, the perpendicular breaking line 20 of one griddle 18, as shown in FIG. 4, can be broken with one breaking trap 4.

It is further noted that the representations of the FIGS. 1 on the one hand and 2 to 4 on the other hand are not necessarily different embodiments. A single embodiment of the breaking device 2 can also be constructed such that a ceramic conductor plate 18 can be broken both by a movement into a breaking position upwardly and by a movement into a breaking position downwardly, especially depending on how the weakening line is arranged on the ceramic conductor plate and which direction the breaking direction is of the ceramic conductor plate. It is further noted that the positioning means can be provided as a thin, resilient, e.g. rubber-like, positioning mat in form of a transport belt with which the ceramic conductor plate 18 is displaceable relative to the breaking trap and the pinning device 52, 8. This is especially preferred if displacement of the ceramic conductor plate 18 on a support should, if possible, be avoided. It can also be preferred to move both the breaking trap and the pinning device 52, 8 relatively to a spatially fixed positioning mat instead of moving the positioning mat relative to the breaking trap and pinning device 52, 8, i.e. the breaking trap 4 and pinning device 52, 8 are moved relative to the positioning mat and the ceramic conductor plate 18 from weakening line to weakening line.

1. Breaking device (2) for singularizing ceramic conductor plates (18) along weakening lines (20) on a ceramic conductor plate (18), comprising a breaking trap (4, 6) having support plates (10, 12) displaceable relative to one another, which can be displaced from an initial position in which the support plates (10, 12) adjoin along a breaking line (14) and form a essentially flat support surface (16) into a breaking position in which the support plates (10, 12) are arranged with an angle one to another and a pinning device (52, 8) formed such that it positions the ceramic conductor plate (18) for a breaking operation against the support plates (10, 12),
characterized in
the breaking trap (4, 6) comprising two support plates (10, 12) which adjoin along a breaking line (14),
the pinning device (52, 8) comprising an oblong engagement section which is narrow transverse to a longitudinal direction, and
the breaking device (2) comprising a positioning element (44) which is formed such that it can position the weakening lines (20) consecutively in alignment with and above the breaking line (14).

2. Breaking device (2) according to claim 1, characterized in the support plates (10, 12) comprising breaking line ends (54, 56) adjacent to the breaking lines (14), wherein the breaking trap (4, 6) is formed such that the breaking line ends (54, 56) can selectively be displaced upwardly into a breaking position or downwardly into a breaking position.

3. Breaking device (2) according to claim 1 or 2, characterized in the engagement section (58, 60) of the pinning device (52, 8) being essentially arranged in parallel to the breaking line (14).

4. Breaking device (2) according to one of claims 1 to 3, characterized in the pinning device (52, 8) comprising two parallel engagement sections (58, 60).

5. Breaking device (2) according to claim 4, characterized in the engagement sections (58, 60) being displaceable relative to one another.

6. Breaking device (2) according to one of claims 1 to 5, characterized in the pinning device (52, 8) comprising a breaking knife (8) which is connected to the breaking device (2) such that it can be positioned above a breaking line (14) and moved in direction of and beyond the breaking line (14), wherein the support plates (10, 12) are arranged resiliently such that the breaking line ends (54, 56) of the support plates (10, 12) are displaced downwardly beyond the breaking line (14) into the breaking position during the course of movement of the breaking knife (8).

7. Breaking device (2) according to one of claims 1 to 6, characterized in at least one breaking line end (54, 56) of the support plates (10, 12) of the breaking trap (4, 6) being upwardly displaceable, the support plates (10, 12) being arranged such that during movement of the breaking line end (54, 6) upwardly a fragment of the ceramic conductor plate is exposed for gripping.

8. Breaking device (2) according to claim 7, further comprising a transport element which is formed such that operationally it can be arranged adjacent to the fragment (38) of the ceramic conductor plate (18) and be displaced to transport away the fragment (38).

9. Breaking device (2) according to claim 8, characterized in the positioning element (44) being simultaneously the transport element.

10. Breaking device (2) according to one of claims 1 to 9, further comprising a coupling device (30) which is connected to the support plates (10, 12) of the breaking trap (4, 6) such that the movements of the support plates (10, 12) are synchronized.

11. Breaking device (2) according to one of claims 1 to 10, characterized in a control being provided, which coordinates the movements of the breaking trap (4, 6) with the movement of further elements (52, 8, 44) of the breaking device (2) and comprises an input interface through which the measurements of the ceramic conductor plates (18) to be singularized and the position and/or the distances of the weakening lines (20) arranged thereon and/or the breaking direction can be input.

12. Breaking device (2) according to one of claims 1 to 11, characterized in that a retardation means (42) for the ceramic conductor plate (18) is provided.

13. Breaking device (2) according to one of claims 1 to 12, characterized in that a turning device is provided with which operationally the ceramic conductor plate (18) to be processed and/or its fragments (38) can be rotated about an axis which is perpendicular to the support plates (10, 12).

14. Breaking device (2) according to one of claims 1 to 13, characterized in that a second breaking trap (6) is provided which is arranged in the breaking device (2) such that its breaking line (14) viewed in the plane of the support plates (10, 12) is arranged with an angle relative to the breaking line of the first breaking trap (4).

15. Method for singularizing ceramic conductor plates (18) along weakening lines (20) of the ceramic conductor plate (18), comprising the following steps:
(a) providing a breaking trap (4, 6) having two support plates (10, 12) displaceable relative to one another which can be displaced from an initial position in which the support plates (10, 12) adjoin along a breaking line (14) and form an essentially flat support surface (16) to a breaking position in which both support plates (10, 12) are arranged with an angle toward one another;
(b) positioning a ceramic conductor plate (18) on the support plates (10, 12) in the initial position such that a weakening line (20) along which breaking should occur is essentially above the breaking line (14);
(c) lowering a pinning device (52) comprising two oblong engagement sections (58, 60) on the ceramic conductor plate (18) such that they transmit a pinning force onto the ceramic conductor plate (18) in the zone of two weakening lines (20) adjacent to the weakening line (20), along which breaking should occur;
(d) breaking the ceramic conductor plate (18) by raising the breaking line ends (54, 56) of the support plates (10, 12) of the breaking trap (4, 6) upwardly into the breaking position;
(e) raising the pinning device (52) and releasing the fragments (38) of the ceramic conductor plate (18);
(f) returning the support plates (10, 12) into the initial position;
(g) positioning the ceramic conductor plate (18) on the support plates (10, 12) such that a further weakening line (20) along which breaking should occur is positioned essentially above the breaking line (14); and
(h) repeating steps (c) to (g) until the ceramic conductor plate (18) is broken along the weakening lines (20) along which breaking should occur.

16. Method for singularizing ceramic conductor plates (18) along weakening lines of a ceramic conductor plate (18) comprising the following steps:
(a) providing a breaking trap (4, 6) with two support plates (10, 12) displaceable relative to one another, which can be moved from an initial position in which the support plates (10, 12) adjoin along a breaking line (14) and form an essentially flat surface (16) into a breaking position in which the two support plates (10, 12) are arranged with an angle toward one another;
(b) positioning a ceramic conductor plate (18) on the support plates (10, 12) in the initial position such that a weakening line (20), along which breaking should occur, is essentially above the breaking line (14);
(c) breaking the ceramic conductor plate (18) by lowering a breaking knife (52, 8) essentially aligned with the weakening line (20) against the weakening line (20) and against a predetermined force of the support plates (10, 12) and thereby downwardly displacing the support plates (10, 12) into the breaking position;
(d) raising the breaking knife (52, 8);
(e) returning the support plates (10, 12) to the initial position;
(f) positioning the ceramic conductor plate (18) on the support plates (10, 12) such that a further weakening line, along which breaking should occur, is positioned essentially above the breaking line (14); and
(g) repeating the steps (c) to (f) until the ceramic plate is broken along the weakening lines (20), along which breaking should occur.

17. Method according to claim 15 or 16, further comprising the step of displacing the support plates (10, 12) upwardly to a gripping position to enlarge the gap between the fragments (38, 18) of a ceramic conductor plate (18).

18. Method according to claim 17, further comprising gripping in the gap between the fragments (38, 18) and transporting away one of the fragments (38).

19. Method according to one of claims 15 to 18, wherein the movements of the support plates (10, 12) are performed synchronously.

20. Method according to one of claims 15 to 19 comprising the step of retarding the ceramic conductor plate (18) after positioning.
